(19) United States
(12) Patent Application Publication
(10) Pub. No.: US 2017/0090844 A1
(43) Pub. Date: Mar. 30, 2017

(54) DISPLAY APPARATUS AND SETTING METHOD THEREOF

(71) Applicant: SAMSUNG ELECTRONICS CO., LTD., Suwon-si (KR)

(72) Inventor: Dong-Yeon KIM, Seoul (KR)

(73) Assignee: SAMSUNG ELECTRONICS CO., LTD., Suwon-si (KR)

(21) Appl. No.: 15/280,235

(22) Filed: Sep. 29, 2016

(30) Foreign Application Priority Data
Sep. 30, 2015 (KR) 10-2015-0137419

(51) Int. Cl. G06F 3/14; G06F 3/147; G09G 5/00

(52) U.S. Cl. CPC G06F 3/1423; G09G 5/006; G06F 3/147; G09G 2370/042; G09G 2370/02

(57) ABSTRACT

A display apparatus is disclosed. The display apparatus is connected to an external display apparatus via a network and includes a communicator configured to receive an ID code set for the external display apparatus from the external display apparatus, and a processor configured to determine ID codes that are usable and/or available for use in the display apparatus among a plurality of predetermined ID codes based on the received ID code, and set an ID code selected based on a user command from among the usable or available ID codes as an ID code of the display apparatus. The processor controls the display apparatus based on a control command received from a control device that is set to have an ID code that is identical to an ID code set with respect to the display apparatus.

### CROSS-REFERENCE TO RELATED APPLICATIONS

This application claims priority from Korean Patent Application No. 10-2015-0137419, filed in the Korean Intellectual Property Office on Sep. 30, 2015, the disclosure of which is incorporated herein by reference in its entirety.

### BACKGROUND

1. Field

Apparatuses and methods consistent with aspects of one or more exemplary embodiments relate to a display apparatus and a method of setting the same, and more particularly, to a display apparatus configured to receive a control command from a control device and a method of setting the same.

2. Description of the Related Art

Advancement in the electronic technology has introduced use of a variety of display apparatuses in many fields. In particular, display apparatuses such as TV, PC, laptop computer, tablet PC, cell phone, MP3 player, etc. are widely distributed to such an extent that they are largely used in households.

Recently, to satisfy increasing demands for newer and various functions, efforts have been made to develop a display apparatus in further newer form.

Meanwhile, for convenient control of a display apparatus, it is common to use a control device, such as a remote controller.

Today, increasing number of display apparatuses used in household, public facility and company, etc. has led to increasing the number of control devices to control the same.

Accordingly, various techniques have been developed to individually interlock a pair of display apparatus and a control device in an environment where there is a plurality of display apparatuses and a plurality control devices to control the same.

However, in the case of replacing any one of the plurality of display apparatuses or the plurality of control devices, a user has to go through a new interlocking process, which is inconvenient.

Accordingly, there has been a demand for easily interlocking a display apparatus and a control device.

### SUMMARY

An aspect of the present disclosure is to provide a display apparatus capable of easily setting an ID code of a control device and a method of setting the same.

According to an exemplary embodiment, a display apparatus which is connected to an external display apparatus via a network, may include a communicator configured to receive an ID code set for the external display apparatus from the external display apparatus, and a processor configured to determine ID codes that are usable in the display apparatus among a plurality of predetermined ID codes based on the received ID code, and set an ID code selected according to a user command among the usable ID codes as an ID code of the display apparatus. In this example, the processor controls the display apparatus according to a control command received from a control device that is set to have an ID code that is identical to an ID code set with respect to the display apparatus.

The processor may determine an ID code not set with respect to the external display apparatus from among a plurality of predetermined ID codes as an ID code usable in the display apparatus based on the received ID code.

The apparatus may further include a display, and the processor may control the display to display the ID codes usable in the display apparatus.

The control device may, in response to a user command to select one of the ID codes usable in the display apparatus being input, transmit, to the display apparatus, a signal to set an ID code selected according to the user command as an ID code of the display apparatus, and set the selected ID code as an ID code of the control device.

The apparatus may further include a storage, and the processor may control the storage to store the ID code set with respect to the display apparatus, and transmit the stored ID code to another display apparatus connected to the network according to a request of the another display apparatus.

According to an exemplary embodiment, a network system comprising a plurality of display apparatuses may include a first display apparatus configured to transmit an ID code set with respect to the first display apparatus to a second display apparatus, and a second display apparatus configured to determine ID codes usable in the second display apparatus among a plurality of predetermined ID codes based on the ID code received from the first display apparatus, set an ID code selected according to a user command among the usable ID codes as an ID code of the second display apparatus, and control the second display apparatus according to a control command received from a control device set to have an ID code identical to the ID code set with respect to the second display apparatus.

According to an exemplary embodiment, a method of setting a display apparatus connected to an external display apparatus via a network, the display apparatus comprising a communicator which receives an ID code set with respect to the external display apparatus from the external display apparatus, may include determining ID codes usable in the display apparatus among a plurality of predetermined ID codes based on the received ID code, setting an ID code selected among the usable ID codes according to a user command as an ID code of the display apparatus, and controlling the display apparatus according to a control command received from a control device that is set to have an ID code identical to the ID code set with respect to the display apparatus.

The method may further include determining an ID code not set with respect to the external display apparatus among the plurality of predetermined ID codes as an ID usable in the display apparatus based on the received ID code.

The method may further include controlling a display to display the ID codes usable in the display apparatus.

In this case, the control device may, in response to a user command to select one of the ID codes usable in the display apparatus being input, transmit, to the display apparatus, a signal to set the ID code selected according to the user command as the ID code of the display apparatus, and set the selected ID code as an ID code of the control device.

The method may further include controlling a storage to store the ID code set with respect to the display apparatus, and transmitting the stored ID code to another display apparatus connected to the network according to a request of the another display apparatus.

As described above, according to an exemplary embodiment, a display apparatus may determine usable ID codes by means of an ID code of an external display apparatus received from a network, and thereby a user convenience is enhanced.

### BRIEF DESCRIPTION OF THE DRAWINGS

The above and other aspects of one or more exemplary embodiments will become more apparent by reference to exemplary embodiments thereof which are illustrated in the appended drawings. Understanding that these drawings depict only exemplary embodiments and are not therefore to be considered to be limiting of the scope of the disclosure, the principles herein are described and explained with additional specificity and detail through the use of the accompanying drawings, in which:

FIG. 1A is a view illustrating a display apparatus and a control device, according to an exemplary embodiment;

FIG. 1B is a view illustrating a network of display apparatuses, according to an exemplary embodiment;

FIG. 1C is a table illustrating a plurality of ID codes, according to an exemplary embodiment;

FIG. 2 is a block diagram illustrating a configuration of a display apparatus, according to an exemplary embodiment;

FIG. 3 is a table illustrating settings of a plurality of ID codes, according to another exemplary embodiment;

FIG. 4 is a table illustrating settings of a plurality of ID codes, according to yet another exemplary embodiment;

FIGS. 5A to 5C are views illustrating setting an ID code, according to an exemplary embodiment;

FIG. 6 is a block diagram illustrating a configuration of a display apparatus, according to another exemplary embodiment;

FIG. 7 is a block diagram illustrating a configuration of a display apparatus, according to yet another exemplary embodiment;

FIG. 8 is a block diagram illustrating a detailed configuration of a display apparatus, according to yet another exemplary embodiment; and

FIG. 9 is a flowchart illustrating a method of setting a display apparatus, according to an exemplary embodiment.

### DETAILED DESCRIPTION OF EXEMPLARY EMBODIMENTS

Hereinafter, various exemplary embodiments of the present disclosure will be described with reference to the accompanying drawings.

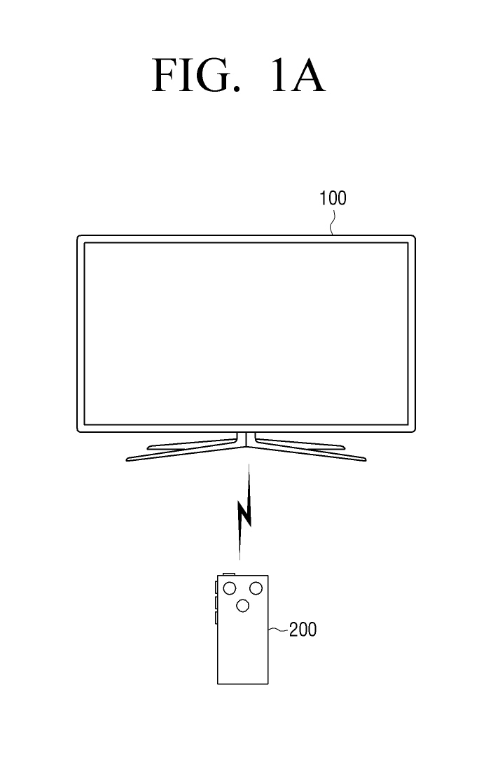

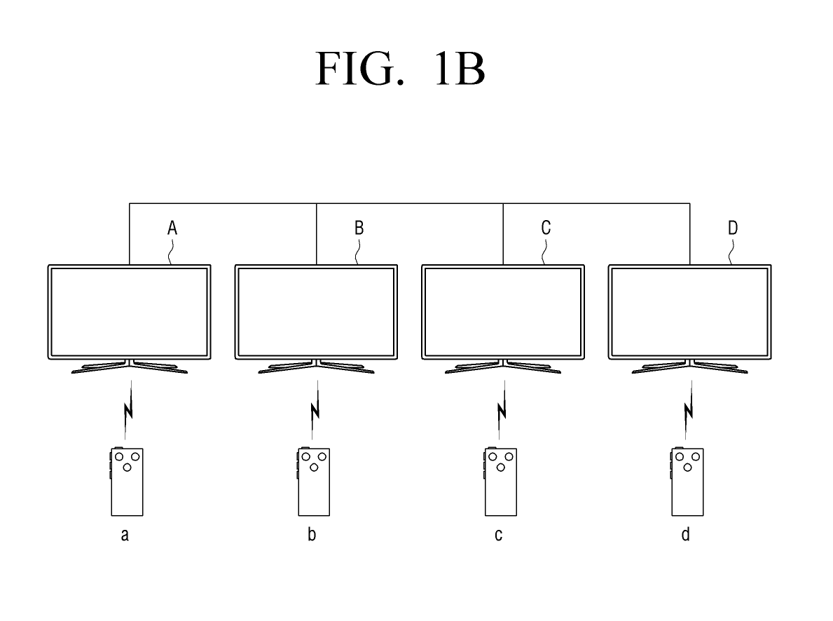

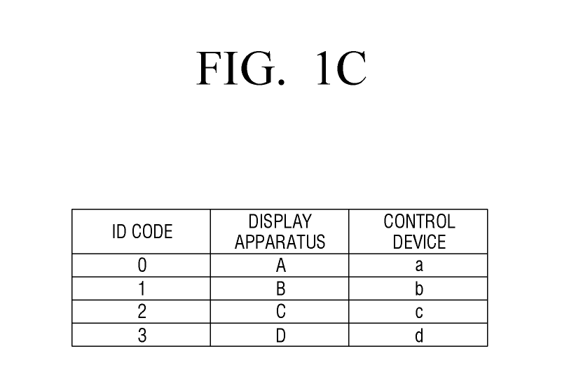

FIG. 1A is a view illustrating a display apparatus 100 and a control device 200 according to an exemplary embodiment.

Referring to FIG. 1A, the display apparatus 100 is interlocked with the control device 200. When the display apparatus 100 is interlocked with the control device 200, the display apparatus 100 performs an operation corresponding to a control signal received from the control device 200.

The below drawings will describe a method of individually interlocking the respective pairs of the display apparatus 100 and the control device 200 when there are a plurality of pairs of the display apparatus 100 and the control device 200, according to an exemplary embodiment.

FIG. 1B is a view illustrating a network of the display apparatus 100 according to an exemplary embodiment.

According to FIG. 1B, a display apparatus network according to an exemplary embodiment includes a plurality of display apparatuses A, B, C and D.

The plurality of display apparatuses A, B, C and D are connected to a network via wire or wirelessly. The plurality of display apparatuses A, B, C and D are respectively connected to a plurality of control devices a, b, c and d to control the plurality of display apparatuses A, B, C and D one to one. For example, the display apparatus A may be connected with the control device a, the display apparatus B with the control device b, the display apparatus C with the control device c, and the display apparatus D with the control device d.

Meanwhile, a plurality of predetermined ID codes are respectively assigned to each of pairs where the plurality of display apparatuses A, B, C and D are associated with the plurality of control devices a, b, c and d. In this case, an ID code may be an identifier that is assigned to prevent malfunction that a control signal transmitted from any one of the control devices is received from an untargeted display apparatus 100 and controlled. As an example of malfunction, in FIG. 1B a control signal transmitted from the control device a may be received by the display apparatus B as well as the display apparatus A to be controlled, and the display apparatus B may be controlled.

FIG. 1C is a table provided to explain settings of a plurality of ID codes according to an exemplary embodiment.

Referring to FIG. 1C, ID codes “0” to “3” are set with respect to pairs where the plurality of display apparatuses A, B, C and D are one-to-one associated with the plurality of control apparatuses a, b, c and d.

Specifically, an ID code “0” is assigned to the display apparatus A and the control device a, an ID code “1”, the display apparatus B and the control device b, an ID code “2”, the display apparatus C and the control device c, and an ID code “3”, the display apparatus D and control device d.

For example, to suppose that the control device a is set with respect to the control device to control the display apparatus A, the display apparatus A should only respond to a control signal transmitted from the control device a and be controlled. For this purpose, the control device a may include the ID code “0” to a control signal and transmit the signal. Accordingly, the display apparatus A which received a control signal from the control device a is operated according to the received control signal, if the received control signal includes the ID code “0”. On the contrary, if the received control signal does not include the ID code “0”, for example, if the ID code included in the control signal is any one of “1” through “3”, the display apparatus does not perform an operation corresponding to the received control signal.

Meanwhile, it may be predetermined that there is a limited number of ID codes. The number of available ID codes may increase according to a memory capacity of a remote controller and the display apparatus 100.

The plurality of display apparatuses A, B, C and D may be realized as a digital TV as illustrated in FIG. 1A, but it is not limited thereto, and may be realized as a various types of apparatuses having a display function, such as a personal computer (C), a navigation, a kiosk, a digital information display (DID), etc. According to circumstances, the display apparatus 100 may be realized as an apparatus that does not have a display function if controllable by the control device 200.

Meanwhile, the display apparatus 100 may receive an ID code used by an external display apparatus 100 via a network and determine an available ID code, and receive a control signal from the control device 200 by means of the determined ID code. Hereinafter, various exemplary embodiments will be described with reference to the accompanying drawings.

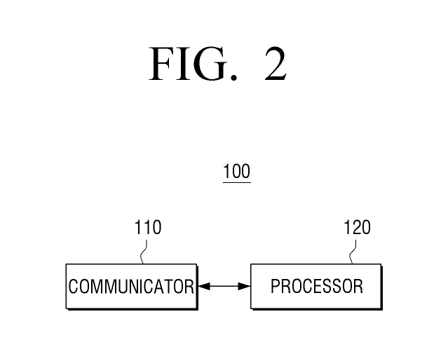

FIG. 2 is a block diagram illustrating a configuration of the display apparatus 100 according to an exemplary embodiment.

According to FIG. 2, the display apparatus 100 includes a communicator 110 and a processor 120. In this case, the display apparatus 100 may be connected with an external display apparatus (not illustrated).

The communicator 110 may receive an ID code set with respect to the external display apparatus (not illustrated) from the external display apparatus (not illustrated). In this case, the ID code was described in the above-mentioned FIGS. 1B and 1C, and so, detailed description thereof will be omitted herein.

Specifically, the external display apparatus (not illustrated) may store an ID code commonly set with a control device (not illustrated) to control the external display apparatus (not illustrated) in a memory included in the external display apparatus (not illustrated). Also, the external display apparatus (not illustrated) may also store the set ID code in an external server (not illustrated).

The ID code of the external display apparatus (not illustrated) stored in the external display apparatus (not illustrated) or in the external server (not illustrated) as such may be transmitted to the communicator (100) according to an occurrence of a predetermined event.

In this example, a predetermined event may be various cases, such as a request for transmitting an ID code by the display apparatus 100, an operation of turning on the display apparatus 100 after a predetermined time elapses, the case where a preset button is selected to access a network, the case where the external display apparatus (not illustrated) is turned on, etc.

Meanwhile, the communicator 110 may communicate with the external display apparatus or the external server (not illustrated) through various communication methods, either via wire or wirelessly.

A processor 120 controls overall operations of the display apparatus 100.

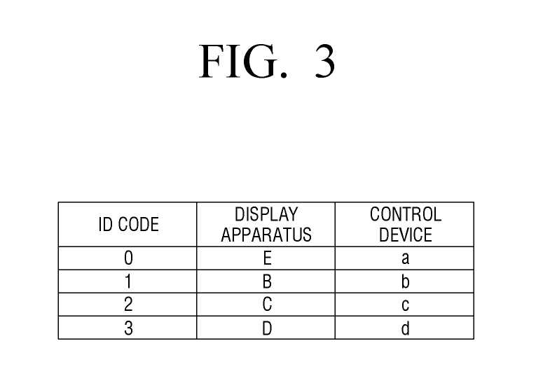

The processor 120 may determine an ID code that is usable in the display apparatus 100 among a plurality of predetermined ID codes based on a received ID code. Specifically, the processor 120 may determine an ID that is not set with respect to the external display apparatus (not illustrated) among a plurality of predetermined ID codes as an ID code that is usable in the display apparatus 100 based on the received ID code. This example will be described with reference to FIG. 3.

FIG. 3 is a table illustrating settings of a plurality of ID codes according to another exemplary embodiment.

FIG. 3 is an example in which a plurality of display apparatuses A, B, C and D are one-to-one connected to a plurality of control devices a, b, c and d and is assigned with an ID code individually, the display apparatus A is replaced with a display apparatus E.

Also, in FIG. 3, it is assumed that ID codes assigned to the plurality of display apparatuses A, B, C and D connected to a network are “0” to “3-”.

If the display apparatus A is replaced with the display apparatus E, a processor (not illustrated) of the display apparatus E may transmit, to a plurality of external display apparatus B, C and D, a request for transmittance of an ID code respectively set with respect to the plurality of external display apparatuses B, C and D. In response to the request, the plurality of external display apparatuses B, C and D may transmit, to the display apparatus E, the set ID code along with a plurality of control devices b, c and d to control the plurality of external display apparatuses B, C and D. In this example, the transmitted ID code may include an ID code “1” which is set with respect to the display apparatus B and the control device b, an ID code “2” which is set with respect to the display apparatus C and control device c and an ID code “3” which is set with respect to the display apparatus C and the control device c.

The processor (not illustrated) of the display apparatus E may contrast ID codes “0” to “3” which are pre-assigned to the plurality of display apparatuses A, B, C and D connected to the network with the received codes “1” to “3”, to determine that an ID code that is not used by the plurality of display apparatuses B, C and D is “0”.

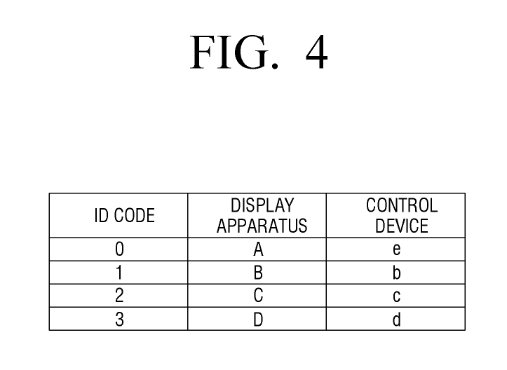

Although it is described above that the display apparatus 100 is being replaced, the processor 120 may reset an ID code even when the control device 200 is being replaced. The above example is described in greater detail based on FIG. 4.

FIG. 4 is a table illustrating settings of a plurality of ID codes according to yet another exemplary embodiment.

FIG. 4 is an example where the control device a is replaced with the control device e in the state that the plurality of display apparatuses A, B, C, and D are one-to-one connected to the plurality of control devices a, b, c, and d and assigned an ID code individually as in FIG. 1C.

Also, it is assumed in FIG. 4 that ID codes assigned to the plurality of display apparatuses connected to a network are “0” to “3”.

If the control device a is replaced with the control device e, a processor (not illustrated) of the display apparatus A may update ID codes set with respect to a plurality of external display apparatuses B, C and D. For this purpose, the processor (not illustrated) of the display A may transmit a request for transmittance of an ID code respectively set with respect to the plurality of external display apparatuses B, C and D to the plurality of external display apparatuses B, C and D.

In response to the request, the plurality of external display apparatuses B, C and D may transmit, to the display apparatus A, the set ID codes along with a plurality of control devices b, c and d to control the plurality of external display apparatuses B, C and D. In this example, the transmitted ID code may include an ID code “1” which is set with respect to the display apparatus B and the control device b, and an ID code “2” which is set with respect to the display apparatus C and the control device c, and an ID code “3” which is set with respect to the display apparatus D and the control device d.

A processor (not illustrated) of the display apparatus A may contrast the ID codes “0” to “3” pre-assigned to the plurality of display apparatuses A, B, C and D connected to a network with the received codes “1” to “3”, and determine that an ID code that is not used by the plurality of display apparatuses B, C and D is “0”.

Meanwhile, there may be a plurality of available codes. For example, in FIG. 4, it may be assumed that ID codes assigned to a plurality of display apparatuses A, B, C and D connected to the network may be “0” to “5”. In this case, as in the above example, the transmitted ID code may include an ID code “1” which is set with respect to the display apparatus B and the control device b, an ID code “2” which is set with respect to the display apparatus C and the control device c, and an ID code “3” which is set with respect to the display apparatus D and the control device d.

A processor (not illustrated) of the display apparatus A may contrast ID codes “0” to “5” pre-assigned to the plurality of display apparatuses A, B, C and D connected to the network with the received codes “1” to “3”, and determine that an ID code not used by the plurality of display apparatuses B, C and D are “0”, “4” and “5”.

In the above examples, it is described that the display apparatus 100 is connected to a network; however, it is also possible that the control device 200 is connected to a network, receives an ID code set with respect to an external control device 200, and determines an available ID code.

For example, FIG. 4 is an example of the case where the control device a is replaced with a control device e in the state that the plurality of display apparatuses A, B, C and D are one-to-one connected to the plurality of control devices a, b, c and d and individually assigned an ID code, as illustrated in FIG. 1C.

Also, in FIG. 4, it is assumed that ID codes that are pre-assigned to a plurality of control apparatuses a, b, c and d connected to a network are “0” to “4”.

When the control device a is replaced with the control device e, a control apparatus e (not illustrated) may update ID codes which are set with respect to the plurality of apparatuses b, c and d. For this purpose, the control apparatus e (not illustrated) may transmit a request for transmittance of an ID code respectively set with respect to a plurality of control apparatuses b, c and d to the plurality of control apparatuses b, c and d.

In response to the request, the plurality of control apparatuses b, c and d may transmit, to the display apparatus A, the set ID code along with the plurality of external display apparatuses B, C and D controlled by the plurality of control apparatuses b, c and d. In this example, the transmitted ID code may include an ID code “1” which is set with respect to the display apparatus B and the control device b, and an ID code “2” which is set with respect to the display apparatus C and the control device c, and an ID code “3” which is set with respect to the display apparatus C and the control device c.

A processor (not illustrated) of the control apparatus e may contrast ID codes “0” to “4” pre-assigned to the plurality of control apparatuses b, c and d connected to a network with the received codes “1” to “3”, and determine that an ID code not used by the plurality of control apparatuses b, c and d is “0”.

Also, in the above-mentioned example, it is described that the control apparatus e determines an available ID code; however, according to another exemplary embodiment, the control apparatus e may also receive ID codes pre-assigned to the plurality of control apparatuses b, c and d from the network, transmit the ID codes to the display apparatus A, and determine ID codes that are usable by the display apparatus A.

Meanwhile, once the usable ID codes are determined, the processor 120 may determine an ID code selected according to a user command among the usable ID codes as an ID code of the display apparatus 100.

For this purpose, the display apparatus 100 may further include a display (not illustrated), and the processor 120 may control the display (not illustrated) to display ID codes that are usable in the display apparatus 100.

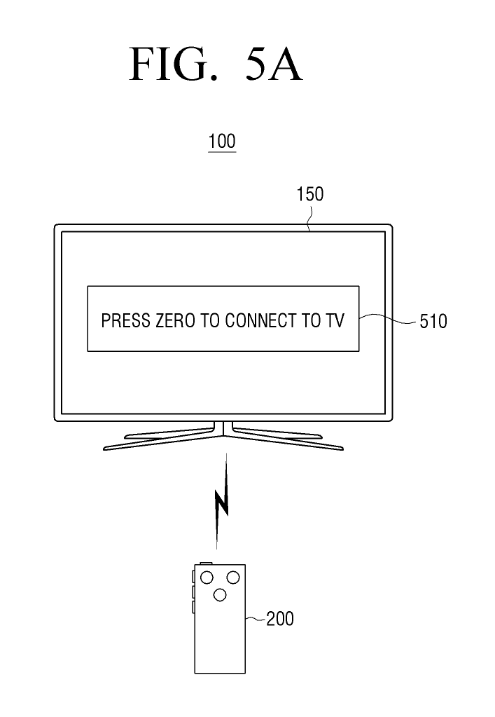

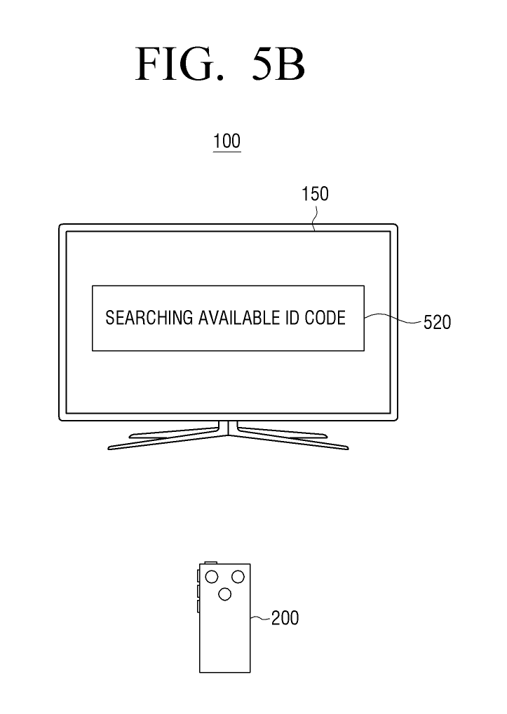

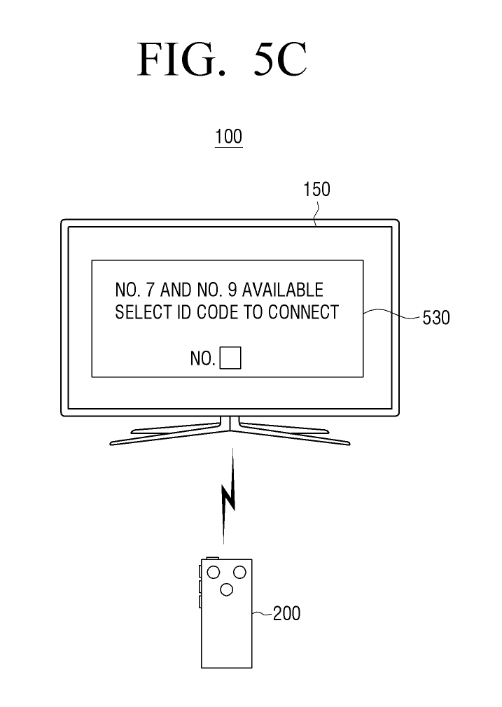

Further, the control device 200 may, when receiving a user command to select one of ID codes usable in the display apparatus 100, transmit a signal to set an ID code selected according to a user command as an ID code of the display apparatus 100 to the display apparatus 100, and set the selected ID code as an ID code of the control device 200. The above example will be described in detail with reference to FIGS. 5A, 5B and 5C.

FIGS. 5A, 5B and 5C are views illustrating a method of setting an ID code according to an exemplary embodiment.

Referring to FIG. 5A, the display apparatus 100 may include a display 150.

In this example, the processor 120 (not shown) may receive a control signal from the control apparatus 200 by means of the communicator 110 (not shown). The processor 120 may, when a predetermined event occurs, generate a GUI 510 on a display 150 to process setting of an ID code by a user, and display the generated GUI on the display 150. In this example, a predetermined event may, as non-limiting examples, a turn on of the display apparatus 100 or the control device 200, an operation of depressing a button included in the control device 200, etc.

In this case, when the user inputs “0” according to the GUI 510 displayed on the display 150, a process of setting an ID code begins.

When “0” is input by the user, the processor 120 may display a GUI 520 which shows a state of determining an ID code on the display 150, as in FIG. 5B.

Subsequently, the processor 120 may, referring to FIG. 5C, display a GUI 530 for the user to select any one of No. 7 and No. 9 determined to be usable ID codes on the display 150.

In this case, the user may select any one of No. 7 and No. 9 using the control device 200, and input the selected code to the display apparatus 100. For example, the processor 120 may, when the user selects No. 7, set an ID code of the display apparatus 100 as No. 7.

Also, the control device 200 may, when No. 7 is input by the user, determine that an ID code of the control device 200 is “7”.

As a result, in the above examples, ID codes of the display apparatus 100 and the control device 200 may be set to be “7”.

When the ID codes of the display apparatus 100 and the control device 200 are set as such, the processor 120 may control the display apparatus 100 according to a control command received from the control device 200 set as an ID code identical to ID code set with respect to the display apparatus 100.

As in the above-mentioned example, the display may autonomously determine an available ID code and present the same to the user, and thereby the user may save trouble having to find available ID codes himself/herself to set ID codes of the display apparatus 100 and the control device 200. Therefore, a user convenience is enhanced.

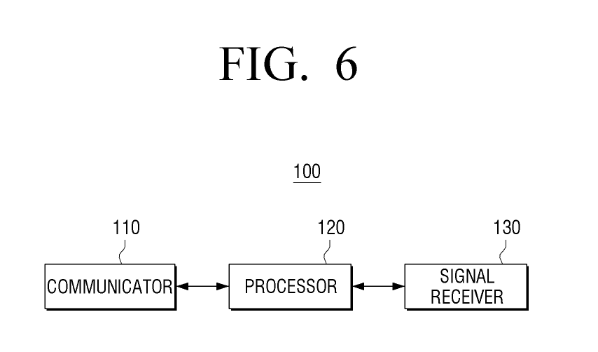

FIG. 6 is a block diagram illustrating a configuration of a display apparatus 100, according to another exemplary embodiment.

According to FIG. 6, the display apparatus 100 includes a communicator 110, a processor 120, and a signal receiver 130. In this example, the communicator 110 and the processor 120 overlap with the above-mentioned description and thus are omitted herein.

In this example, the signal receiver 130 may communicate with the control device 200 using an infrared (IR) method; however, it is not limited thereto, and it may communicate with the control device 200 using various communication methods as well.

Specifically, the signal receiver 130 may, when a predetermined even occurs, communicate with the display apparatus 100 according to a predetermined communication method and be in an interlocked state. In this example, an interlocking may refer to all states where communication is possible, such as an operation of initializing communication between the display apparatus 100 and the control device 200, an operation of forming a network, an operation of pairing up of devices, etc.

For example, using the signal receiver 130, when receiving an ID code from the control device 200 according to a predetermined communication method, the processor 120 may set the received ID code as an ID code of the display apparatus 100 and be interlocked with the control device 200.

Meanwhile, the control device 200 may include an ID code in a control signal to control the display apparatus 100 to control the display apparatus 100. Specifically, when the signal receiver 130 of the display apparatus 100 receives a control signal including an ID code from the control device 200, the processor 120 may determine whether the received control signal includes an ID code set as an ID code of the display apparatus 100. If the control signal includes the ID code set as the ID code of the display apparatus, the processor 120 performs a control operation corresponding to the control signal. On the other hand, when the control signal does not include the ID code of the display, the processor 120 does not perform an operation according to the corresponding control signal.

For example, suppose that an ID code simultaneously set with respect to the display apparatus 100 and the control device 200 is “1”. In this case, the control device 200 may include an ID code “1” in a particular control signal and transmit the signal to the display apparatus 100. When receiving the control signal, the processor 120, since the control signal includes the ID code “1”, performs a control operation corresponding to the received control signal.

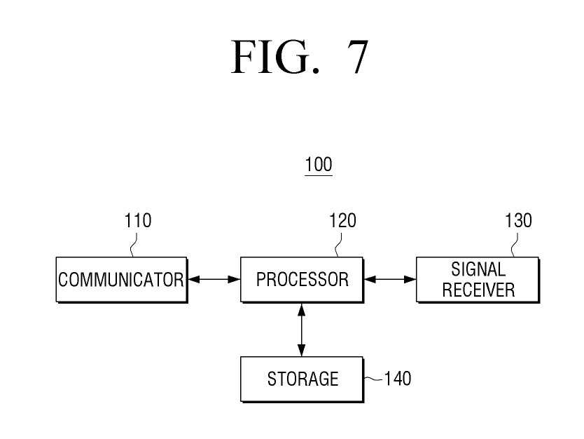

FIG. 7 is a block diagram illustrating a configuration of a display apparatus 100, according to yet another exemplary embodiment.

According to FIG. 7, a display apparatus 100 includes a communicator 110, a processor 120, a signal receiver 130, and a storage 140. In this example, the communicator 110, the processor and the signal receiver 130 overlap with the above description and thus are omitted herein.

The storage 140 may be a memory which stores an ID code set with respect to the display apparatus 100.

Specifically, the processor 120 may control the storage 140 to store the ID code set with respect to the display apparatus 100, and transmit the stored ID code to another display apparatus connected to a network (not illustrated) according to a request of the another display apparatus.

For example, among a plurality of display apparatuses (not illustrated) connected to a network, if a first display apparatus (not illustrated) is replaced with a second display apparatus (not illustrated), the second display apparatus (not illustrated) may transmit a request to a third display apparatus (not illustrated) connected to the network for identification on an ID code set with respect to the third display apparatus (not illustrated). According to the request for ID code information, the third display apparatus (not illustrated) may transmit an ID code stored in a storage included in the third display apparatus (not illustrated) to the second display apparatus (not illustrated).

Meanwhile, according to another exemplary embodiment, a network system consisting of a plurality of display apparatuses (not illustrated) may include a first display apparatus (not illustrated) and a second display apparatus (not illustrated).

Specifically, the first display apparatus (not illustrated) may transmit an ID code set with respect to the first display apparatus (not illustrated) to the second display apparatus (not illustrated). The second display apparatus (not illustrated) may determine ID codes usable in the second display apparatus (not illustrated) among a plurality of predetermined ID codes based on the received ID code, set an ID code selected according to a user command among the usable ID codes as an ID code of the second display apparatus (not illustrated), and control the second display apparatus (not illustrated) according to a control command received from a control device 200 set to have an ID code identical to the ID code set with respect to the second display apparatus (not illustrated).

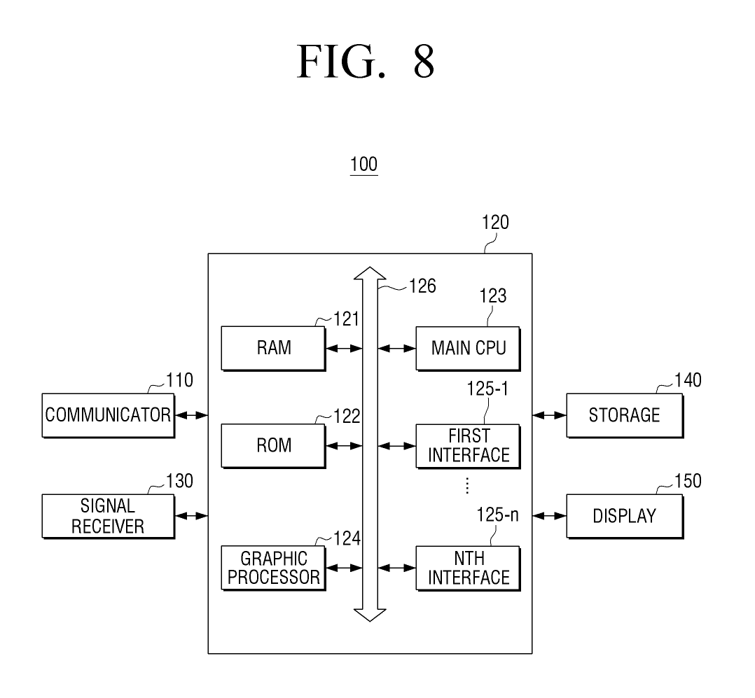

FIG. 8 is a block diagram illustrating a detailed configuration of a display apparatus 100, according to an exemplary embodiment.

According to FIG. 8, the display apparatus 100 includes a communicator 110, a processor 120, a signal receiver 130, and a storage 140 (such as a memory). Among the elements illustrated in FIG. 8, the detailed description of those overlapping with the elements illustrated in FIGS. 2, 6 and 7 will be omitted.

The processor 120 may be configured to control an overall operation of the display apparatus 100 using various programs stored in the storage 140.

The processor 20 may include, for example, a RAM 121, a ROM 122, a main CPU 123, a graphic processor (e.g., a GPU) 123, first to nth interfaces 125-1 to 125-n, and bus 126.

In this example, a RAM 121, a ROM 122, a main CPU 123, a graphic processor 124, and first to nth interfaces 125-1 to 125-n may be connected to one another via bus 126.

The first to nth interfaces 125-1 to 125-n are connected to the aforementioned various features. One of the interfaces may be, as a non-limiting example, a network interface connected to an external apparatus via network.

The main CPU 123 accesses the storage 140 and performs booting using the 0/S stored on the storage 140. Then, the main CPU 274 performs various operations using various programs, contents, data, etc. stored on the storage 140.

A command word set for booting a system, etc. are stored on the ROM 122. When a command to turn on power is input and power is supplied, the main CPU 123 copies an operating system (0/S) stored on the storage 140 according to a command word stored on the ROM 122, and executes the 0/S to boot the system. When the booting is complete, the main CPU 123 copies various application programs stored on the storage 140, and executes the application programs copied onto the RAM 121 and performs various operations.

The graphic processor 124 generates a screen including various objects, such as an icon, an image, a text, and the like, using a computation unit and a rendering unit. The computation unit (not illustrated) computes an attribute value, such as a coordinate value where each object is displayed, a form, a size, a color, and the like, according to a screen layout using a received control command. The rendering unit (not illustrated) generates a screen of various layouts including objects including an attribute value calculated in the computation unit (not illustrated).

Meanwhile, the above-mentioned operations of the processor 120 may be performed by a program stored in the storage 140.

The storage 140 may store various data, such as an operating system (O/S) software module to drive the display apparatus 100, various multimedia contents, etc.

In particular, the storage 140 may store a set ID code, and the stored ID code may, when receiving a signal which requests for an ID code from an external display apparatus, be transmitted to an external apparatus.

The display 150 outputs various images. For example, the display 150 may display various screens generated in the graphic processor 124.

For this purpose, the display 150 may be realized as a liquid crystal display (LCD), an organic light emitting display (OLED), etc.

Meanwhile, the display 150 may further include additional configurations according to a method of realization. For example, if the display 150 uses a liquid crystal method, the display 150 may include an LCD display panel, a backlight unit which supplies light to the LCD display panel, a panel driving substrate to drive the panel, etc.

Additionally, the display apparatus 100 may further include an audio processor (not illustrated) which processes audio data, a video processor (not illustrated) which processes video data, a speaker (not illustrated) which outputs not only various audio data processed in the audio processor (not illustrated) but also various alert sounds or voice messages, etc., a microphone (not illustrated) for receiving a user voice or other sounds to convert it to audio data, etc.

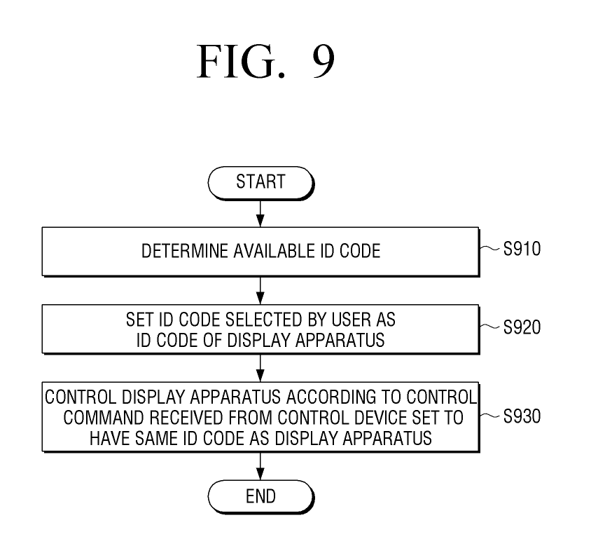

FIG. 9 is a flowchart of a method of an electronic apparatus, according to an exemplary embodiment.

First, when determining ID codes usable in the display apparatus 100 among a plurality of predetermined ID codes based on a received ID code at step S910, a display apparatus sets an ID selected according to a user command among the usable ID codes as an ID code of the display apparatus 100, at step S920. Once an ID code is set, the display apparatus controls the display apparatus according to a control command received from the control device 200 set to have an ID code identical to the ID code set with respect to the display apparatus 100, at step S930. In this case, the display apparatus 100 may be realized in the form of having a communicator which receives an ID code set with respect to an external display apparatus 100 from the external display apparatus 100.

In this example, the setting method may further include the step of determining an ID code not set with respect to the external display apparatus 100 among a plurality predetermined ID codes based on the received ID code as an ID code usable in the display apparatus 100.

Also, the method may further include an operation of controlling the display to display an ID code usable in the display apparatus 100.

In this case, the control device 200 may, when receiving a user command to select one of the ID codes usable in the display apparatus 100, transmit a signal to set an ID code selected according to a user command as an ID code of the display apparatus, and set the selected ID code as an ID code of the control device 200.

Also, the method may further include the step of controlling a storage to store the ID code set with respect to the display apparatus 100 and the step of transmitting the stored ID code to another display apparatus 100 according to a request of another display apparatus 100 connected to the network.

The aforementioned methods of setting the display apparatus 100 according to the various exemplary embodiments may be implemented as a program code executable by a computer, and the code may be stored in a non-transitory computer-readable medium to be executed by the processor 120.

For example, a non-transitory computer readable medium may be installed to include a program which performs a display apparatus setting method including determining ID codes usable in a display apparatus among a plurality of predetermined ID codes based on a received ID code, setting an ID code selected according to a user command among the usable ID codes as an ID code of the display apparatus, and when an ID code is set, controlling the display apparatus according to a control command received from the control device 200 set to have an ID code identical to the ID code set with respect to the display apparatus.

A non-transitory computer readable medium may refer to a machine-readable medium or device that stores data semi-permanently and not for a short period of time, such as a register, cache, memory, and the like. The exemplary embodiments described herein have been presented for description and understanding of the technical details, but are not intended to limit the scope of the present disclosure.

The exemplary embodiments described herein have been presented for description and understanding of the technical details, but are not intended to limit the scope of the present disclosure. Therefore, the scope of the present disclosure should be construed to include all changes or various other exemplary embodiments based on the technical spirit of the present disclosure. Therefore, the scope of the present disclosure is defined, not by the detailed description and exemplary embodiments, but by the following claims and their equivalents.

What is claimed is:

1. A display apparatus which is connected to an external display apparatus via a network, the apparatus comprising:
a communicator configured to receive, from the external display apparatus, an identification (ID) code, which is set for the external display apparatus; and
a processor configured to determine at least one ID code that is usable in the display apparatus from among a plurality of predetermined ID codes based on the received ID code, and set an ID code of the display apparatus,
wherein the ID code is selected from among the at least one usable ID code, based on a user input, and
wherein the processor controls the display apparatus based on a control command received from a control device that is set to have the set ID code.

2. The apparatus as claimed in claim 1, wherein the processor determines which ID code is not set with respect to the external display apparatus from among a plurality of predetermined ID codes, wherein the ID code, which is determined as not set for the external display apparatus, is available for use by the display apparatus.

3. The apparatus as claimed in claim 1, further comprising:
a display,
wherein the processor controls the display to display the ID codes available for the display apparatus.

4. The apparatus as claimed in claim 1, wherein, in response to the user input selecting one of the ID codes, the control device transmits, to the display apparatus, a signal to set the ID code of the display apparatus, and to set the selected ID code as an ID code of the control device.

5. The apparatus as claimed in claim 1, further comprising:
a memory,
wherein the processor controls the memory to store the set ID code, and transmits the stored ID code to another display apparatus connected to the network according to a request from the another display apparatus.

6. A method of pairing a display apparatus to a control device, the display apparatus is connected to an external display apparatus via a network, the method comprising:
receiving, by the display apparatus, an identification (ID) code set with respect to the external display apparatus;
determining at least one ID code available for the display apparatus from among a plurality of predetermined ID codes, based on the received ID code;
setting the determined ID code as an ID code of the display apparatus, based on user input; and
controlling the display apparatus according to a control command received from a control device that is set to have the same ID code as the display apparatus.

7. The method as claimed in claim 6, further comprising:
determining, based on the received ID code, at least one available ID code, which is an ID code that is not set with respect to the external display apparatus from among the plurality of predetermined ID codes.

8. The method as claimed in claim 6, further comprising:
controlling a display of the display apparatus to display the at least one available ID code.

9. The method as claimed in claim 6, wherein, in response to receiving a user input selecting one of the available ID codes, the control device transmits, to the display apparatus, a signal to set the ID code, selected by the user input, as the ID code of the display apparatus, and sets the selected ID code as an ID code of the control device.

10. The method as claimed in claim 6, further comprising:
a memory configured to store the ID code set with respect to the display apparatus; and
transmitting the stored ID code to another display apparatus connected to the network according to a request of the another display apparatus.

11. A network system comprising a plurality of display apparatuses, the system comprising:
a first display apparatus configured to transmit, to a second display apparatus, an identification (ID) code assigned to the first display apparatus; and
a second display apparatus configured to determine at least one ID code available for the second display apparatus from among a plurality of predetermined ID codes based on the ID code received from the first display apparatus, set an ID code from among the determined at least one available ID code as an ID code of the second display apparatus, based on user input, and control the second display apparatus according to a control command received from a control device with the same assigned ID code as the second display apparatus.
